(19) United States
(12) Patent Application Publication
(10) Pub. No.: US 2015/0108772 A1
(43) Pub. Date: Apr. 23, 2015

(54) REMOVABLE SEAL DEVICE FOR USE WITH A LATCH

(71) Applicant: VSI, LLC, Green Bay, WI (US)

(72) Inventor: Lucas Boesel, Muskego, WI (US)

(21) Appl. No.: 14/515,746

(22) Filed: Oct. 16, 2014

Related U.S. Application Data
(60) Provisional application No. 61/891,989, filed on Oct. 17, 2013.

(51) Int. Cl. E05B 17/00; E05C 1/02

(52) U.S. Cl. CPC E05B 17/002; E05C 1/02
USPC 292/307 R

(57) ABSTRACT

The device comprises a box-like housing having a spring-loaded locking plate. The locking plate is secured but movable within the housing. When the locking plate is in a retracted position, which places the device in an “open” position, the device can be positioned over a latch. The locking plate can then be released, which places the device in a “closed” position and allows the device to capture the latch. Once the locking plate is released, a portion of the locking plate extends downwardly from the housing. The downwardly-extending portion of the locking plate includes an aperture, which allows the locking plate to be secured by means of a lock, such as a conventional padlock.

This Application claims the benefit of U.S. Provisional Application No. 61/891,989, filed Oct. 17, 2013.

### FIELD OF THE INVENTION

The present invention relates generally to locks and to other security devices that use locks and locking mechanisms. More specifically, it relates to a removable seal device that is used to secure the latch of the door of a truck storage compartment, or to secure other similar latches that are used for other purposes. It also relates to such a removable seal device that is simple in construction and easy to use.

### BACKGROUND OF THE INVENTION

Latches that are used for securing truck storage compartment doors are well known in the art. One particular type of latch supports and secures a horizontal bar by means of two connected structures. One structure is a generally J-shaped holder and the other is a generally L-shaped drop-down or hanging latch member. The L-shaped latch member is configured to be rotatably secured to the back portion of the J-shaped holder. The structures are provided with complementary apertures through which the generally U-shaped shackle of a conventional padlock can be inserted such that the two structures can be locked together. In the relevant art, the complementary apertures are used to attach a seal to the latch hasp after the truck storage compartment has been loaded with product. If this seal is damaged in any way, or is missing altogether, when the product is delivered, the compartment contents may be considered “suspect” and the load may not be accepted.

### SUMMARY OF THE INVENTION

What is needed is a unitary, one-piece device or assembly that can be used to secure the latch of a truck storage compartment door locking mechanism. The present invention provides such a device that, when used properly, helps to prevent the latch or a seal that may be used with the latch from being compromised at all times during which the assembly is used. The device of the present invention provides for a unique locking device having a number of components that form the unitary device. The device comprises a box-like housing having a spring-loaded locking plate. The locking plate is secured but movable within the housing. When the locking plate is in a retracted position, which places the device in an “open” position, the device can be positioned over a latch. The locking plate can then be released, which places the device in a “closed” position and allows the device to capture the latch. Once the locking plate is released, a portion of the locking plate extends downwardly from the housing. The downwardly-extending portion of the locking plate includes an aperture, which allows the locking plate to be secured by means of a lock, such as a conventional padlock. The foregoing and other features of the removable seal device of the present invention will be apparent from the detailed description that follows.

### BRIEF DESCRIPTION OF THE DRAWINGS

FIG. 1 is a rear perspective view of the removable seal device of the present invention and showing the device in the “closed” position.

FIG. 2 is a perspective view similar to that shown in FIG. 1 and showing the device in the “open” position.

FIG. 3 is a rear perspective view of the housing of the device of the present invention.

FIG. 4 is a view similar to FIG. 3 and showing the locking plate placed within the housing of the present invention.

FIG. 5 is an enlarged view of the compression springs and locking plate placed within the housing.

FIG. 6 is a view similar to FIG. 4 but showing the locking plate secured to the housing by use of an elongated bushing.

FIGS. 7A through 7C show partially sectioned and side perspective views of the removable seal device showing the locking plate as installed and showing the device in the “closed” and “open” positions, respectively.

FIGS. 8A through 8C are perspective views of the removable seal device and showing the device affixed to a trailer latch.

### DETAILED DESCRIPTION OF THE INVENTION

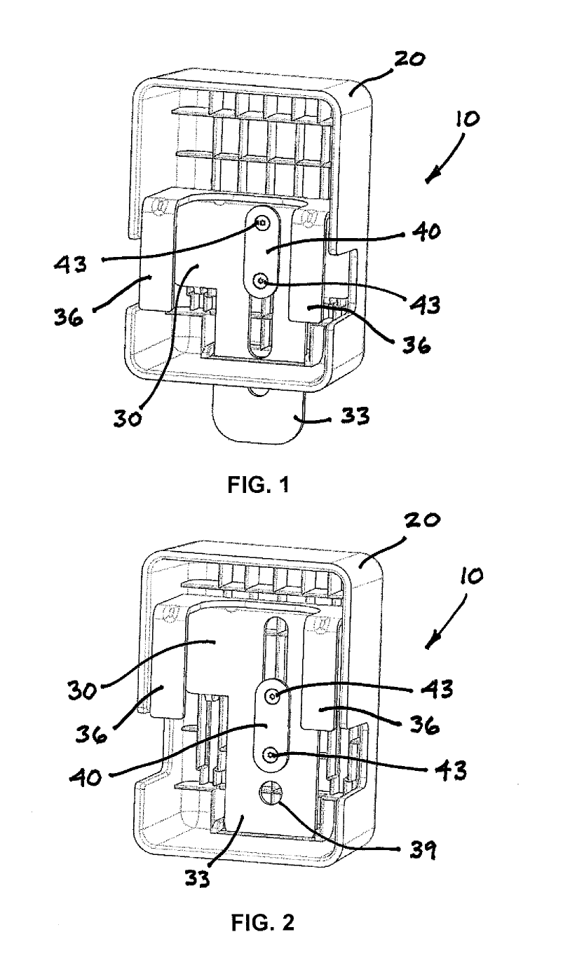

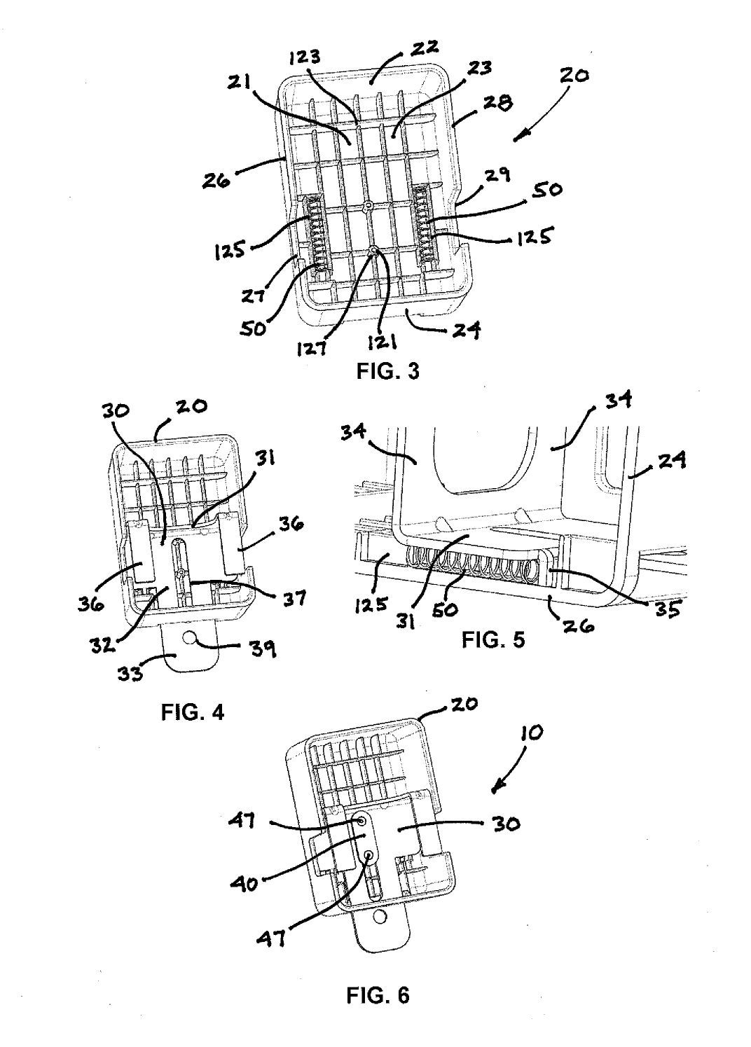

Referring now to the drawings in detail, FIG. 1 is a perspective view showing the removable seal device, generally identified 10, that is constructed in accordance with the present invention. The device 10 comprises a housing 20, a locking plate 30 and an elongated bushing 40, the bushing 40 being used in conjunction with fasteners 43 to secure the locking plate 30 within the housing 20. The device 10 further comprises a pair of springs 50. See FIGS. 3 and 5.

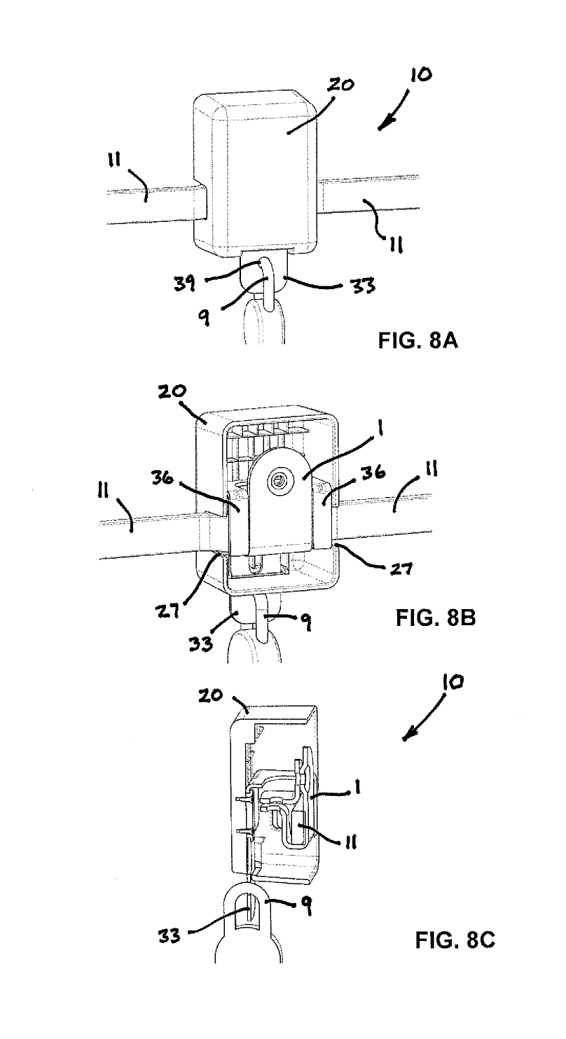

The device 10 is intended to be used with a conventional locking mechanism that is known in the art. See FIGS. 8A-8C. The mechanism comprises a generally J-shaped holder and a generally L-shaped drop-down or hanging latch member. The L-shaped latch member is configured to be rotatably secured to the back portion of the J-shaped holder. The structures are provided with complementary apertures through which a seal may be inserted as is described above.

FIG. 3 illustrates the housing 20 of the device 10. The housing 20 comprises a box-like structure having a front wall 21, a top wall 22, a bottom wall 24 and opposing first and second side walls 26, 28. Although the precise shape of the housing 20 is not a limitation of this invention, the housing 20 of the preferred embodiment comprises a front wall 21 that is disposed in a substantially vertical plane, as are the side walls 26, 28. The top wall 22 and the bottom wall 24 are disposed in substantially horizontal planes. In the preferred embodiment, the front, top, bottom and side walls 21, 22, 24, 26, 28 are injection molded to form a one-piece integrally-formed structure. The front wall 21 comprises a rear face 23 having reinforcing ribbing or lattices 123 defined within it. Disposed within the ribbing or lattices 123 are spring cradles 125 and fastening apertures 121. Each spring cradle 125 is configured to receive a spring 50 within it, each spring 50 being used to impart a force on a locking plate 30, as will be discussed below. The rear face 23 of the front wall 21 comprises a pair of raised members 127 surrounding the fastener apertures 121. Lastly, each side wall 26, 28 of the housing 20 includes a side wall opening 27, 29, respectively.

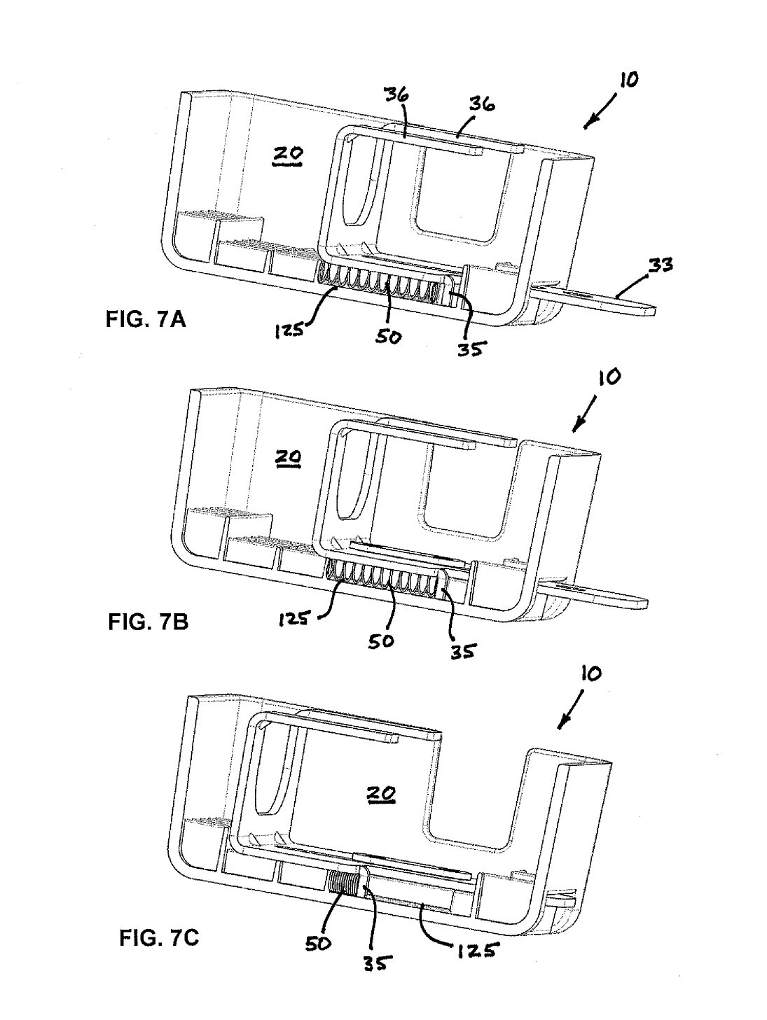

FIGS. 4 and 7A-7C illustrate the structural details of the locking plate 30. The locking plate 30 is a substantially U-shaped structure having a substantially vertical front plate-like face 32 having an upper edge 31 and a bottom portion 33. The locking plate 30 further comprises a substantially horizontal top portion 34 extending rearwardly from the upper edge 31 of the front face 32. Two legs 36 extend downwardly from the top portion 34 and are disposed in a substantially vertical plane. The front face 32 further comprises a pair of forwardly-extending tabs 35, the tabs 35 being aligned generally with the spring cradles 125. The front face 32 further comprises a centrally-disposed slot 37 and a substantially circular aperture 39, the circular aperture 39 being disposed at the bottom portion 33 of the front face 32.

The locking plate 30 is secured to the housing 20 by means of an elongated bushing 40. See FIG. 6. The elongated bushing 40 comprises a pair of apertures (not shown) that are aligned with the raised members 127 about the fastener apertures 121 of the rear face 23 of the front wall 21 of the housing 20. With the front face 32 of the locking plate 30 disposed between the housing 20 and the bushing 40, fasteners 47 can be inserted through the apertures 42 of the bushing 40 and into the fastener apertures 121 in the raised members 127 of the housing 20. In this position, the locking plate 30 is vertically-movable relative to the rear face 23 of the front wall 21 of the housing 20. See FIGS. 1, 2 and 6.

During attachment of the locking plate 30 to the housing 20, a spring 50 is positioned within each spring cradle 125. See FIG. 3. The top of each spring 50 is disposed against the upper portion of that spring cradle 125. The bottom of the spring 50 is disposed against a tab 35 of the locking plate 30. See FIG. 5. In this fashion, the spring 50 imparts a force on the locking plate tabs 35 and urges the locking plate 30 downwardly to the normally closed position as shown in FIGS. 1 and 7A-7C. Thus, the default position of the device 10 is that it be normally closed.

In application, the locking plate 30 is pushed upwardly into the housing 20 to the position as is shown in FIG. 7C. The device 10 is positioned over the latch 1 such that the latch arm 11 extends to either side of the latch 1 and through the side wall openings 27, 29 of the housing side walls 26, 28. In this fashion, each of the legs 36 of the locking plate 30 “catches” a portion of the latch arm 11. See FIGS. 8A and 8B. The shackle 9 of a padlock can then be inserted through the circular aperture 39 of the locking plate 30 to secure the device 10 about the latch 1 and latch arm 11 until removal is desired or required. The device 10 of the present invention is simple to use and contains a minimal number of parts. Moreover, the device 10 is reusable.

Additional advantages and modifications will readily occur to those skilled in the art. Therefore, the invention in its broader aspects is not limited to the specific details disclosed and described herein. Accordingly, various modifications may be made without departing from the spirit or scope of the general inventive concept.

I claim:

1. A removable seal device for use with a latch, the device comprising:
a housing comprising a housing interior;
a vertically-movable locking plate, the plate comprising a pair of legs;
an elongated bushing;
fasteners for attaching the elongated bushing to the housing interior; and
a pair of springs for imparting a force on the locking plate.

2. The removable seal device of claim 1 wherein the housing comprises a front wall that is disposed in a vertical plane; a top wall and a bottom wall, each of the top and bottom walls being disposed in a horizontal plane; and opposing first and second side walls, the side walls being disposed in a vertical plane; and wherein the front wall further comprises a rear face and the elongated bushing is attached to the rear face of the housing via the fasteners.

3. The removable seal device of claim 2 wherein the housing walls form a unitary structure.

4. The removable seal device of claim 2 wherein each of the first and second side walls comprises a side wall opening to allow latch arm portions of a latch to pass through such side wall openings.

5. The removable seal device of claim 4 wherein the locking plate is a U-shaped structure comprising a front face having a top edge and a bottom portion; a pair of tabs formed in the bottom portion of the front face, the tabs extending forwardly of the front face; an aperture disposed at the bottom portion of the front face; a top portion extending rearwardly from the top edge of the front face; and a pair of legs extending downwardly from the top portion.

6. The removable seal device of claim 5 wherein the housing further comprises a pair of spring cradles, each cradle being configured to receive a spring within it.

7. The removable seal device of claim 6 wherein each one of the front face tabs of the locking plate engages one end of each spring that is disposed within a spring cradle.

8. The removable seal device of claim 7 wherein the locking plate is movable from a downward and normally closed position to an upward position.

9. The removable seal device of claim 8 wherein a shackle of a padlock can be passed through the aperture disposed at the bottom portion of the front face of the locking plate to secure the device about the latch and latch arms.

10. A removable seal device for use with a latch, the latch being used to support and secure horizontally-disposed latch arms by means of a J-shaped holder and an L-shaped drop-down latch member, the L-shaped latch member being configured to be rotatably secured to the back portion of the J-shaped holder, the holder and latch member being provided with complementary apertures through which the U-shaped shackle of a padlock can be inserted such that the holder and latch member can be locked together, the device comprising:
a housing comprising a housing interior;
a vertically-movable locking plate, the plate comprising a pair of legs and the legs being positioned apart horizontally such that one leg can be disposed to each side of the latch and behind the latch arms to either side of the latch;
an elongated bushing;
fasteners for attaching the elongated bushing to the housing interior; and
a pair of springs for imparting a force on the locking plate.

11. The removable seal device of claim 10 wherein the housing comprises a front wall that is disposed in a vertical plane; a top wall and a bottom wall, each of the top and bottom walls being disposed in a horizontal plane; and opposing first and second side walls, the side walls being disposed in a vertical plane; and wherein the front wall further comprises a rear face and the elongated bushing is attached to the rear face of the housing via the fasteners.

12. The removable seal device of claim 11 wherein the housing walls form a unitary structure.

13. The removable seal device of claim 11 wherein each of the first and second side walls comprises a side wall opening to allow the latch arms to pass through such side wall openings.

14. The removable seal device of claim 13 wherein the locking plate is a U-shaped structure comprising a front face having a top edge and a bottom portion; a pair of tabs formed in the bottom portion of the front face, the tabs extending forwardly of the front face; an aperture disposed at the bottom portion of the front face; and a top portion extending rearwardly from the top edge of the front face; wherein the pair of legs extend downwardly from the top portion of the locking plate.

15. The removable seal device of claim 14 wherein the housing further comprises a pair of spring cradles, each cradle being configured to receive a spring within it.

16. The removable seal device of claim 15 wherein each one of the front face tabs of the locking plate engages one end of each spring that is disposed within a spring cradle.

17. The removable seal device of claim 16 wherein the locking plate is movable from a downward and normally closed position to an upward position.

18. The removable seal device of claim 17 wherein the padlock shackle can be passed through the aperture disposed at the bottom portion of the front face of the locking plate to secure the device about the latch and the latch arms.
